(19) United States
(12) Patent Application Publication
(10) Pub. No.: US 2013/0046689 A1
(43) Pub. Date: Feb. 21, 2013

(54) System and Method for Facilitating Transactions

(71) Applicants: Ian Erik Sundberg, Charlotte, NC (US); Cary Edward Moore, Webster, TX (US); William E. Kelley, Charlotte, NC (US); Michael Toth, Charlotte, NC (US)

(72) Inventors: Ian Erik Sundberg, Charlotte, NC (US); Cary Edward Moore, Webster, TX (US); William E. Kelley, Charlotte, NC (US); Michael Toth, Charlotte, NC (US)

(73) Assignee: Bank of America Corporation, Charlotte, NC (US)

(21) Appl. No.: 13/210,798

(22) Filed: Aug. 16, 2011

(51) Int. Cl. G06Q 40/00

(52) U.S. Cl. 705/42; 235/379

(57) ABSTRACT

A system includes a memory for storing user account information and mobile device information; and a processor. The processor receives a request for a transaction. The request includes a user identifier, a transaction amount, and a transaction recipient identifier. The processor further generates a transaction code. The processor further communicates the transaction code to a user device. The processor further receives, from a mobile device, a transaction confirmation message, wherein the user device and the mobile device are separate devices. The transaction confirmation message includes a confirmation of the request for the transaction and a unique identifier of the mobile device. The processor further compares the unique identifier of the mobile device with the stored mobile device information. In response to a determination that the unique identifier of the mobile device matches the stored mobile device information, the processor further allows the transaction to occur.

### TECHNICAL FIELD

This disclosure relates generally to the field of transactions and more specifically to a system and method for facilitating transactions.

### BACKGROUND

In order to conduct a transaction between a user and a recipient, a user typically requests the particular transaction (such as a transfer of $200 to Person A), and an enterprise allows the transaction to occur. This may result in the $200 being transferred to Person A. Unfortunately, this method is problematic. For example, an unauthorized person may be able to access a user's account (such as by accessing a user's online account with the enterprise using unauthorized methods) and cause unauthorized transactions to occur. For example, the unauthorized person may cause $1000 to be transferred to the unauthorized person, adversely effecting both the user and the enterprise.

### SUMMARY OF THE DISCLOSURE

According to one embodiment, a system includes a memory for storing user account information associated with a user and mobile device information associated with the user account; and a processor. The processor receives a request for a transaction associated with the user account. The request includes a user identifier, a transaction amount, and a transaction recipient identifier. The processor further generates a transaction code based on the user identifier, the transaction amount, and the transaction recipient identifier. The processor further communicates the transaction code to a user device. The processor further receives, from a mobile device, a transaction confirmation message, wherein the user device and the mobile device are separate devices. The transaction confirmation message includes a confirmation of the request for the transaction and a unique identifier of the mobile device. The processor further compares the unique identifier of the mobile device with the stored mobile device information associated with the user account. In response to a determination that the unique identifier of the mobile device matches the stored mobile device information associated with the user account, the processor further allows the transaction to occur.

Certain embodiments of the disclosure may provide one or more technical advantages. For example, before a transaction is allowed to occur, a transaction code may be generated and communicated to a user. This may allow the user to view details regarding the transaction and confirm whether they are correct. As another example, a mobile device associated with the user may communicate a confirmation of the request and a unique identifier of mobile device. This may allow for a determination that the request for the transaction has been confirmed, and further allow for a determination that the request has been confirmed by a mobile device that is associated with the user's account. In particular embodiments, this may provide an extra level of security because even if an unauthorized person is able to request an unauthorized transaction and confirm the request, the confirmation may not be received from a mobile device associated with the user's account. Accordingly, in particular embodiments, this may prevent the unauthorized transaction from occurring.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that facilitates transactions between users and recipients;

FIG. 2A illustrates an example request that may be received by a device in order to facilitate a transaction between a user and a recipient;

FIG. 2B illustrates an example transaction code that may include information regarding a transaction between a user and a recipient;

FIG. 2C illustrates an example transaction confirmation message that may be received by a device in order to facilitate a transaction between a user and a recipient;

FIG. 2D illustrates an example data set utilized by a device in order to determine whether to approve a transaction; and

FIG. 3 illustrates a method for facilitating transactions between users and recipients.

### DETAILED DESCRIPTION OF THE DRAWINGS

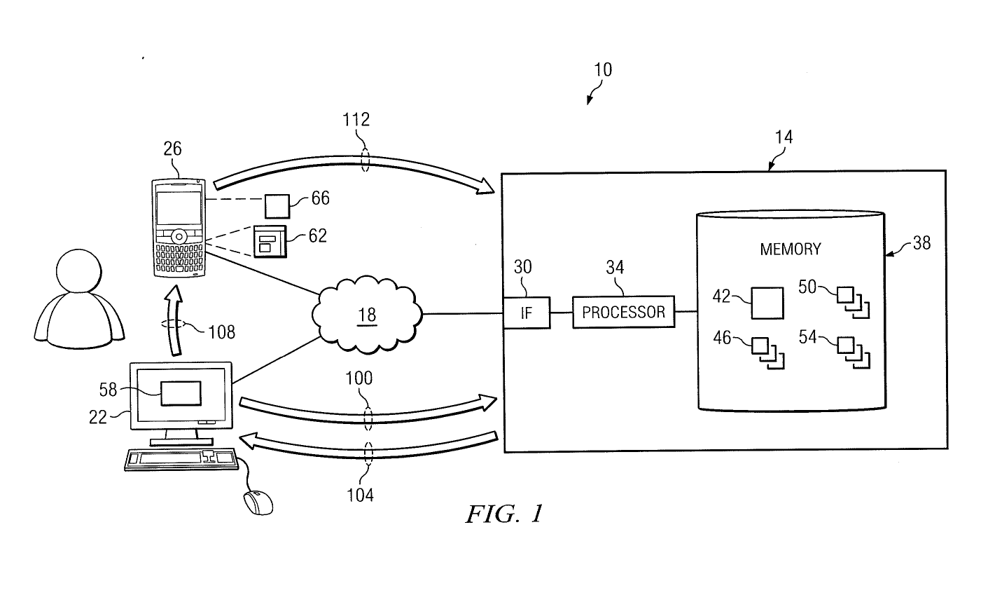

Embodiments of the present disclosure are best understood by referring to FIGS. 1 through 3 of the drawings, like numerals being used for like and corresponding parts of the various drawings.

FIG. 1 illustrates a system 10 that facilitates transactions between users and recipients. System 10 includes an enterprise (e.g., financial institution) device 14 that receives, a request for a transaction over one or more networks 18 from a user device 22, and generates a transaction code for communication to user device 22. Device 14 further receives a confirmation of the request and a unique identifier from a mobile device 26. If information received from mobile device 26 matches information stored at device 14, device 14 may allow the transaction to occur. In particular embodiments, this may provide a more secure transaction process.

A financial institution represents an institution, such as a bank, that communicates with users in order to facilitate transactions between the users and recipients. The financial institution facilitates transactions for users that have a credit card account, a savings account, a debit card account, a checking account, or any other account associated with the financial institution. Although the following description is detailed with respect to a financial institution, system 10 may be implemented with respect to any suitable enterprise organization.

A recipient represents an entity that conducts a transaction with a user. The recipient may include a person or company associated with the user, a retailer, a wholesaler, a service company, or any other entity that conducts transactions with the users. The transaction may include a money transfer, a wire transfer, an Automated Clearing House (ACH) transfer, a bill pay, or any other transaction-based function provided by an enterprise (such as a financial institution).

In order to conduct a transaction between a user and a recipient, a user typically requests the particular transaction (such as a transfer of $200 to Person A), and the financial institution associated with the user allows the transaction to occur. This may result in the $200 being transferred to Person A. Unfortunately, this method is problematic. For example, an unauthorized person may be able to access a user's account (such as by accessing a user's online account with the financial institution using unauthorized methods) and cause unauthorized transactions to occur. For example, the unauthorized person may cause $1000 to be transferred to the unauthorized person, adversely effecting both the user and the financial institution.

In particular embodiments, system 10 of FIG. 1 may facilitate transactions in a manner that may provide various advantages. For example, before a transaction is allowed to occur, device 14 may generate a transaction code and communicate the transaction code to user device 22. This transaction code may be provided by user device 22 to mobile device 26, allowing the user to view details regarding the transaction and confirm whether they are correct. Additionally, mobile device 26 may communicate a confirmation of the request and a unique identifier of mobile device 26 to device 14. This may allow device 14 to determine that the request for the transaction has been confirmed, and further determine that the request has been confirmed by a mobile device that is associated with the user's account. This may provide an extra level of security because even if an unauthorized person is able to request an unauthorized transaction and confirm the request, the confirmation may not be received from a mobile device associated with the user's account. Accordingly, in particular embodiments, device 14 may prevent the unauthorized transaction from occurring.

Device 14 represents any components that facilitate transactions between users and recipients. Device 14 may include a network server, any remote server, a mainframe, a host computer, a workstation, a web server, a personal computer, a file server, or any other device operable to facilitate transactions between users and recipients. The functions of device 14 may be performed by any combination of one or more servers or other components at one or more locations. In the embodiment where the module is a server, the server may be a private server, and the server may be a virtual or physical server. The server may include one or more servers at the same or remote locations. Also device 14 may include any component that functions as a server. In the illustrated embodiment, device 14 includes a network interface 30, a processor 34, and a memory 38.

Network interface 30 represents any device operable to receive information from network 18, transmit information through network 18, perform processing of information, communicate to other devices, or any combination of the preceding. For example, network interface 30 receives a request for a transaction from user device 22. As another example, network interface 30 communicates a transaction code to user device 22. Network interface 30 represents any port or connection, real or virtual, including any suitable hardware and/or software, including protocol conversion and data processing capabilities, to communicate through a local area network (LAN), a metropolitan area network (MAN), a wide area network (WAN), or other communication system that allows device 14 to exchange information with network 18, user device 22, mobile device 26, or other components of system 10.

Processor 34 communicatively couples to network interface 30 and memory 38, and controls the operation and administration of device 14 by processing information received from network interface 30 and memory 38. Processor 34 includes any hardware and/or software that operates to control and process information. For example, processor 34 executes device management application 42 to control the operation of device 14. Processor 34 may be a programmable logic device, a microcontroller, a microprocessor, any processing device, or any combination of the preceding.

Memory 38 stores, either permanently or temporarily, data, operational software, or other information for processor 34. Memory 38 includes any one or a combination of volatile or non-volatile local or remote devices suitable for storing information. For example, memory 38 may include random access memory (RAM), read only memory (ROM), magnetic storage devices, optical storage devices, or any other information storage device or a combination of these devices. While illustrated as including particular modules, memory 38 may include any information for use in the operation of device 14.

In the illustrated embodiment, memory 38 includes device management application 42, user account information 46, mobile device information 50, and transaction data 54. Device management application 42 represents any suitable set of instructions, logic, or code embodied in a computer-readable storage medium and operable to facilitate the operation of device 14.

User account information 46 represents any information regarding user and/or commercial accounts handled by device 14. For example, user account information 46 includes account numbers, nicknames for accounts, account identifiers associated with an account, balance information of an account, limits of an account, disclaimers associated with an account, user preferences, any other data, or any combination of the preceding. In particular embodiments, user account information 46 represents any information regarding an account for each of the individual and/or corporate users associated with a financial institution.

Mobile device information 50 represents any information that may identify a mobile device associated with a user's account. For example, mobile device information 50 may refer to a phone number, unique mobile device identification information, mobile device geo-location information, or any other information that may uniquely identify a mobile device. In particular embodiments, mobile device information 50 may be associated (or linked) to user account information 46. As such, accessing user account information 46 for a particular user may allow mobile device information 50 to also be accessed. Thus, device 14 may be able to determine the identification of a particular mobile device 26 associated with a particular user's account.

Transaction data 54 may represent any information associated with a particular transaction. For example, transaction data 54 may refer to information received from the request for a transaction and/or information created based on the request for the transaction. In particular embodiments, transaction data 54 may be stored for every transaction that is requested. In particular embodiments, this may allow transaction data 54 for a particular transaction to be compared to transaction information received from mobile device 26 in the confirmation of the request. As such, device 14 may be able to determine that the requested transaction referred to in the confirmation includes the same information as the transaction that was initially requested.

Network 18 represents any network operable to facilitate communication between the components of system 10, such as device 14, user device 22, and mobile device 26. Network 18 may include any interconnecting system capable of transmitting audio, video, signals, data, messages, or any combination of the preceding. Network 18 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

User device 22 represents any components that allow a user to request a transaction. User device 22 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to allow a user to request a transaction. In particular embodiments, user device 22 may further receive a transaction code from device 14 and communicate the transaction code to mobile device 26. User device 22 may comprise a user interface, such as a display, a microphone, keypad, or other appropriate terminal equipment usable by a user.

User device 22 may display a graphical user interface 58 in order to allow a user to conduct a transaction. Graphical user interface 58 may include any graphical interface that allows a user to request a particular transaction. For example, graphical user interface 58 may allow a user to input one or more pieces of information in order to generate the request for a transaction. In particular embodiments, the user may input information in any manner, for example, the user may type in the information using a keyboard on user device 22, may select information from a pull-down list displayed on graphical user interface 58, may input the information in any other manner, or any combination of the proceeding. Graphical user interface 58 may further allow a transaction code for the requested transaction to be provided to mobile device 26. For example, graphical user interface 58 may display the transaction code so that mobile device 26 may take a picture of the transaction code, scan the transaction code, or receive the transaction code in any other manner. In particular embodiments, graphical user interface 58 may be accessible to a user through a web browser.

Mobile device 26 represents any components that may receive a transaction code and communicate a confirmation of the request to device 14. In particular embodiments, mobile device 26 and user device 22 may be separate devices. For example, while user device 22 may be a computer, mobile device 26 may be a Smartphone associated with the user. Furthermore, although mobile device 26 and user device 22 may be separate devices, both mobile device 26 and user device 22 may be accessible by the user. For example, the user may utilize user device 22 in order to request a particular transaction. Furthermore, the user may utilize mobile device 26 in order to confirm the request. In particular embodiments, mobile device 26 is associated with the user's account with the financial institution. As such, in particular embodiments, the confirmation of the request must be communicated by mobile device 26 in order for device 14 to allow the transaction to occur. Therefore, although a transaction may be requested from any device, the confirmation of the request must be communicated from a particular mobile device 26. In particular embodiments, this may prevent unauthorized transactions.

Mobile device 26 may include a personal computer, a workstation, a laptop, a wireless or cellular telephone, a Smartphone, an electronic notebook, a personal digital assistant, or any other device (wireless, wireline, or otherwise) capable of receiving, processing, storing, and/or communicating information with other components of system 10. Mobile device 26 may comprise a user interface, such as a display, a microphone, a keypad, a camera, a scanner (such as for scanning an image), or other appropriate terminal equipment usable by a user. Mobile device 26 executes a mobile application 62. Mobile application 62 represents any software or logic for receiving, generating, and/or communicating information to other components of system 10 in order for a user to conduct a transaction with a recipient. The user associated with mobile device 26 may enter access credentials into mobile application 62 in order to conduct a transaction. The accessed credentials may include a user name and/or a password.

Mobile device 26 may further include unique identifier 66. Unique identifier 66 represents any identifier that may uniquely identify mobile device 26. For example, unique identifier 66 may include an International Mobile Equipment Identity (IMEI), an Integrated Circuit Card Identifier (ICCID), an International Mobile Subscriber Identity (IMSI), an authentication key for a subscriber identification module (SIM) installed in mobile device 26, any other identifier that uniquely identifies mobile device 26, or any combination of the preceding. In particular embodiments, unique identifier 66 may allow device 14 to determine that a particular transaction is authentic. For example, mobile device information 50 stored by device 14 may include a copy of the unique identifier represented by unique identifier 66. As such, device 14 may be able to compare unique identifier 66 of mobile device 26 to the unique identifier in mobile device information 50 in order to determine that the confirmation of the request was communicated by a mobile device associated with the user's account. If it was not, the transaction may be unauthorized, and device 14 may prevent the transaction from occurring.

In an exemplary embodiment of operations, a user may desire to conduct a transaction with a recipient (such as, for example, a transfer of $200 to Person A). In order to do so, the user may communicate a request message 100 from user device 22 to device 14. In response to receiving request message 100, device 14 may provide a transaction code to user device 22. This transaction code may be further provided from user device 22 to mobile device 26 via reception method 108. After receiving the transaction code, mobile device 26 may display information included in the transaction code, such as details of the requested transaction. For example, mobile device 26 may display a message stating that the user has requested a transfer of $200 to Person A. This may allow the user to confirm that the details are correct or incorrect. If the user confirms that the details of the requested transaction are correct, mobile device 26 may communicate a transaction confirmation message 112 to device 14. This may allow device 14 to determine, based on various comparisons of information included in transaction confirmation message 112 and information stored at device 14, whether to approve the transaction. If it is determined that the transaction is approved, device 14 may allow the transaction to occur, resulting in Person A receiving $200. Further details regarding particular embodiments of the sequences illustrated in FIG. 1 are discussed below.

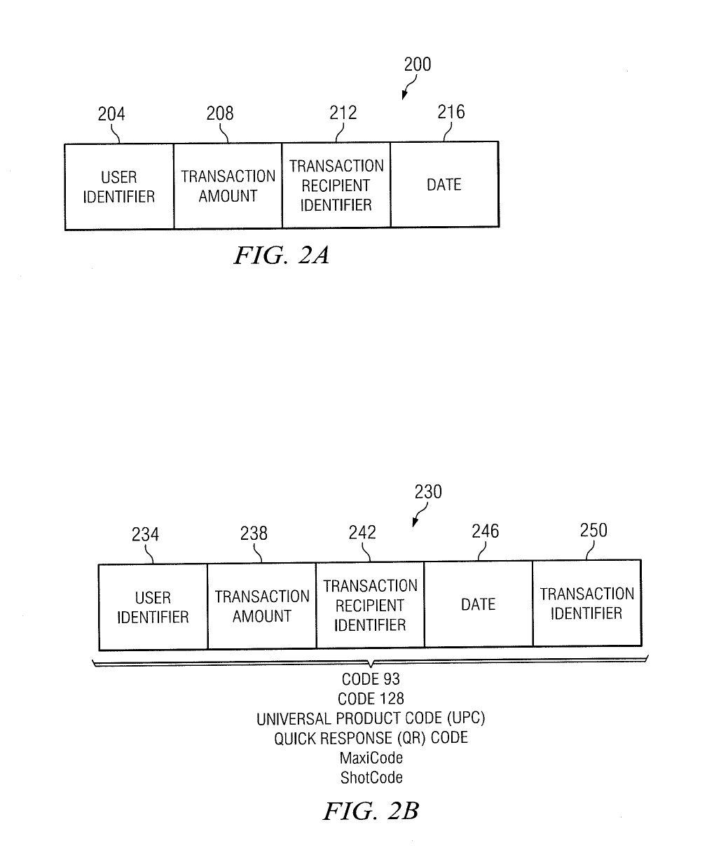

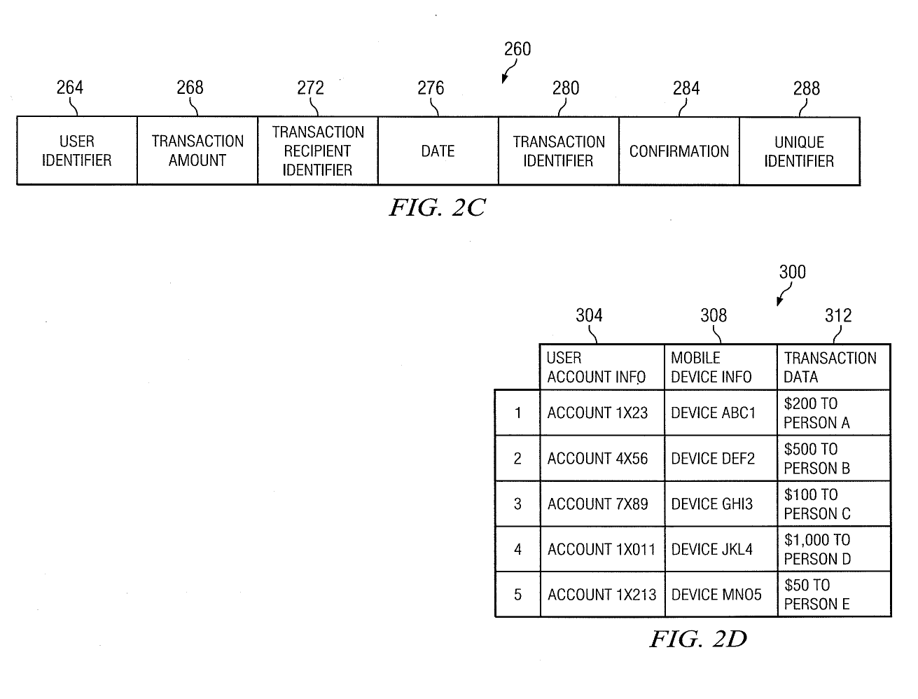

As is stated above, device 14 receives request message 100 from user device 22. Request message 100 may include a request for a transaction between a user and a recipient. The request for a transaction may include any information regarding a particular transaction. For example, the request for the transaction may include a user identifier, a transaction amount, a transaction recipient identifier, a transaction date, any other information regarding the transaction, or any combination of the preceding. In particular embodiments, request message 100 may include transaction data 54 and/or may include information that allows device 14 to create and store transaction data 54. Further details regarding this information is discussed in detail in FIG. 2A.

After device 14 receives request message 100, device 14 may use the request for the transaction in order to determine whether to authorize the requested transaction. Device 14 may determine whether to authorize the requested transaction in any manner. For example, device 14 may compare a transaction amount of the requested transaction with a remaining balance in an account associated with the user.

In response to a determination that the requested transaction is authorized, device 14 generates transaction code message 104 for communication to user device 22. Transaction code message 104 includes a transaction code. The transaction code may be any type of transaction code. For example, the transaction code may be in the form of a linear barcode (or a one dimensional barcode), such as a code 93, a code 128, or a universal product code (UPC); a matrix barcode (or a two dimensional barcode), such as a Quick Response (QR) code, a MaxiCode, or a ShotCode; a sequence of numbers and/or symbols; any other transaction code; or any combination of the preceding. The transaction code may include any information regarding the requested transaction. For example, the transaction code may embody all (or a portion) of the information of the requested transaction. In particular embodiments, the transaction code may further include a transaction identifier that identifies a particular transaction. In particular embodiments, device 14 may utilize the transaction identifier in order to search for a particular transaction, manage a particular transaction, or keep track of a particular transaction. In particular embodiments, this may allow device 14 to compare information received in request confirmation message 112 with information associated with a particular transaction. Further details regarding this information is discussed in FIG. 2B.

After transaction code message 104 has been communicated to user device 22, the transaction code is received by mobile device 26 via reception method 108. Reception method 108 may represent any method for receiving the transaction code. For example, reception method 108 may represent mobile device 26 taking (or receiving) a picture of the transaction code displayed on user device 22. In such an example, the transaction code may be an image in the form of a linear barcode, matrix barcode, a sequence of numbers and/or symbols, any other image, or any combination of the preceding. In particular embodiments, taking (or receiving) a picture of the transaction code displayed on user device 22 may include mobile device 26 scanning the transaction code included in the picture so as to extract information from the transaction code. In particular embodiments, mobile device 26 may also scan the transaction code directly from the display of user device 22.

Although the transaction code has been described as being received by mobile device 26 from user device 22, in particular embodiments, the transaction code may be sent directly to mobile device 26 from device 14. As such, after determining that the requested transaction is authorized, device 14 may communicate the transaction code directly to mobile device 26 (thus, bypassing user device 22).

After receiving the transaction code, mobile application 62 of mobile device 26 may display information included in the transaction code. For example, if the requested transaction was for a transfer of $200 to Person A, mobile application 62 may display a message that indicates that a $200 transfer to Person A was requested. In particular embodiments, this may allow a user to determine whether details associated with the requested transaction are correct. For example, if the user requested a transfer of $200 to Person A, but for some reason (such as user error, financial institution error, communication error, or reasons associated with an unauthorized person) the displayed message indicates a transfer of $500 to Person A, the user may be able to deny the requested transaction. In particular embodiments, if the requested transaction is denied, mobile application 62 may communicate the denial to device 14 so as to prevent the transaction from occurring, or mobile application 62 may prevent any communication from being sent to device 14 so as to cause the transaction to expire. In particular embodiments, mobile application 62 may display the details regarding the transaction in any manner. For example, mobile application 62 may extract information from the transaction code, translate the information from the transaction code into the message, and display the message.

In particular embodiments, although FIG. 1 illustrates a message regarding the details of the requested transaction being displayed, in particular embodiments, a message regarding the details of the requested transaction may not be displayed. For example, mobile application 62 may be able to determine that the transaction code received by mobile device 26 was not intended to be received by mobile device 26. For example, mobile application 62 may compare an identifier associated with the transaction code to an identifier associated with mobile application 62 or mobile device 26 in order to determine whether the transaction code was intended to be received by mobile device 26. In particular embodiments, if it is determined that transaction code was not intended to be received by mobile device 26, mobile application 62 may display an error message.

If the user determines that the displayed details regarding the requested transaction are correct, mobile application 62 may receive confirmation of the requested transaction from the user. In particular embodiments, the confirmation may be communicated to mobile application 62 in any manner. For example, the user may select a confirmation button displayed on mobile device 26 by mobile application 62, the user may provide a vocal confirmation, or the user may perform any other manner of confirmation.

After mobile application 62 receives the user confirmation, mobile application 62 may extract unique identifier 66 from mobile device 26. Mobile application 62 may extract unique identifier 66 in any manner. For example, mobile application 62 may request unique identifier 66 from mobile device 26 or any component of mobile device 26, may intercept a message that includes unique identifier 66, or may perform any other action for extracting unique identifier 66. In particular embodiments, mobile application 62 may dynamically extract unique identifier 66 from mobile device 26. For example, each time mobile device 26 receives a transaction code and further receives the confirmation from the user, mobile application 62 may extract unique identifier 66. In particular embodiments, this may prevent mobile application 62 from using a previously extracted unique identifier 66.

Once mobile application 62 has extracted unique identifier 66 from mobile device 26, mobile application 62 may generate and communicate transaction confirmation message 112 to device 14. Transaction confirmation message 112 may include any information that may allow device 14 to determine whether to approve the transaction. For example, transaction confirmation message 112 may include the confirmation for the request of the transaction, unique identifier 66 of mobile device 26, transaction information associated with the transaction (such as one or more pieces of information from the transaction code or the actual transaction code, itself), and/or any other information. Further details regarding this information is discussed in FIG. 2C.

Once device 14 receives transaction confirmation message 112, device 14 may use transaction confirmation message 112 in order to determine whether to approve the transaction. In particular embodiments, device 14 may determine whether to approve the transaction by comparing information included in transaction confirmation message 112 with information stored in memory 38, such as user account information 46, mobile device information 50, and/or transaction data 54. In particular embodiments, device 14 may compare unique identifier 66 included in transaction confirmation message 112 with a unique identifier included in mobile device information 50. If they match, device 14 may determine that the confirmation of the request is authentic (e.g., since it was received from a mobile device that is associated with the user's account). In particular embodiments, the information may match when the information is the same (e.g., such as when the unique identifier 66 in transaction confirmation message 112 is the same as the unique identifier included in mobile device information 50).

In particular embodiments, device 14 may further compare transaction information included in transaction confirmation message 112 with transaction data 54 (e.g., which was included in and/or generated based on request message 100). If the information matches, device 14 may determine that none of the information for the transaction has been altered, and therefore, the transaction is authentic. In particular embodiments, the information may match when the information is the same (e.g., such as when the transaction information included in transaction confirmation message 112 is the same as transaction data 54 for that transaction). For example, if transaction information included in transaction confirmation message 112 indicates that the transaction is a transfer of $200 to Person A, the information may match when transaction data 54 also indicates that the transaction is a transfer of $200 to Person A.

If device 14 determines that the unique identifier 66 included in transaction confirmation message 112 matches a unique identifier included in mobile device information 50, and/or that the transaction information included in transaction confirmation message 112 matches transaction data 54, device 14 may determine to approve the transaction, and therefore may allow the transaction to occur. In particular embodiments, device 14 may allow the transaction to occur in any manner. For example, device 14 may facilitate a transfer of a transaction amount to the recipient associated with the transaction (e.g., if the transaction is a transfer of $200 to Person A, device 14 may facilitate the transfer of $200 to Person A). In particular embodiments, device 14 may facilitate the transaction by actually performing the transaction, causing another device to perform the transaction, performing any other action to facilitate the transaction, or any combination of the preceding. In particular embodiments, if one or more of the pieces of information do not match, device 14 may prevent the transaction from occurring.

Modifications, additions, or omissions may be made to system 10 without departing from the scope of the invention. For example, device 14 may facilitate any number of transactions for any number of users and/or recipients. Additionally, system 10 may include any number of devices 14, networks 18, user devices 22, and/or mobile devices 26. Any suitable logic may perform the functions of system 10 and the components within system 10.

FIG. 2A illustrates an example request 200 that may be received by device 14 in order to facilitate a transaction between a user and a recipient. In particular embodiments, request 200 may be an example of request message 100 of FIG. 1. According to the illustrated embodiment, request 200 includes user identifier 204, transaction amount 208, transaction recipient identifier 212, and date 216. In particular embodiments, request 200 may include more or less information depending on particular implementations.

User identifier 204 represents any data that may identify a particular user. For example, user identifier 204 may include the user's name, the user's address, the user's social security number, an online identifier associated with the user, an account number associated with the user, any other information that identifies the user, or any combination of the preceding. In particular embodiments, device 14 may utilize user identifier 204 in order to determine which user is providing request 200.

Transaction amount 208 represents any data that may identify an amount of money that is needed to conduct the transaction between the user and the recipient. For example, transaction amount 208 may include any suitable amount of money, such as $1, $10, $100, $1,000 dollars, or any other appropriate amount.

Transaction recipient identifier 212 represents any data that may identify a recipient with which the user desires to conduct a transaction. For example, transaction recipient identifier 212 may include the recipient's name, the recipient's address, the recipient's social security number, an online identifier associated with the recipient, an account number associated with the recipient, any other information that identifies the recipient, or any combination of the preceding. In particular embodiments, device 14 may utilize transaction recipient identifier 212 in order to determine with which recipient the user desires to conduct a transaction.

Date 216 represents any data that may identify a date associated with the transaction. In particular embodiments, by providing date 216, device 14 may know when the user desires the transaction to occur. As such, device 14 may only allow the transaction to occur on or after date 216.

In particular embodiments, request 200 may include any other information. For example, request 200 may include information associated with a time, a description of the transaction (e.g., such as for accounting purposes), or any other information.

In particular embodiments, after device 14 receives request 200, device 14 may store one or more pieces of information included in request 200 as transaction data 54. For example, device 14 may store one or more of the data represented by user identifier 204, transaction amount 208, transaction recipient identifier 212, and/or date 216 as transaction data 54. As such, device 14 may use this information in order to determine whether or not to approve the transaction.

FIG. 2B illustrates an example transaction code 230 that may include information regarding a transaction between a user and a recipient. In particular embodiments, transaction code 230 may be an example of the transaction code provided to user device 22 in transaction code message 104, and further received by mobile device 26 via reception method 108. According to the illustrated embodiment, transaction code 230 includes user identifier 234, transaction amount 238, transaction recipient identifier 242, date 246, and transaction identifier 250. In particular embodiments, transaction code 230 may include more or less information depending on particular implementations.

User identifier 234 represents any data that may identify a particular user. In particular embodiments, user identifier 234 of FIG. 2B may be substantially similar to user identifier 204 of FIG. 2A. In particular embodiments, user identifier 234 of FIG. 2B may be different than user identifier 204 of FIG. 2A. For example, although both user identifier 234 of FIG. 2B and user identifier 204 of FIG. 2A may identify the same user, a different type of identifier may be used as user identifier 234 of FIG. 2B than user identifier 204 of FIG. 2A. As an example, user identifier 234 of FIG. 2B may identify the user by an account number associated with the user, and user identifier 204 of FIG. 2A might identify the user by an online identifier associated with the user.

Transaction amount 238 represents any data that may identify an amount of money that is needed to conduct the transaction between the user and the recipient. In particular embodiments, transaction amount 238 of FIG. 2B may be substantially similar to transaction amount 208 of FIG. 2A. In particular embodiments, although transaction amount 238 of FIG. 2B and transaction amount 208 of FIG. 2A may identify the same amount of money, transaction amount 238 of FIG. 2B may be different than transaction amount 208 of FIG. 2A.

Transaction recipient identifier 242 represents any data that may identify a recipient with which the user desires to conduct a transaction. In particular embodiments, transaction recipient identifier 242 of FIG. 2B may be substantially similar to transaction recipient identifier 212 of FIG. 2A. In particular embodiments, although transaction recipient identifier 242 of FIG. 2B and transaction recipient identifier 212 of FIG. 2A may identify the same recipient, transaction recipient identifier 242 of FIG. 2B may be different than transaction recipient identifier 212 of FIG. 2A.

Date 246 represents any data that may identify a date associated with the transaction. In particular embodiments, date 246 of FIG. 2B may be substantially similar to date 216 of FIG. 2A. In particular embodiments, although date 246 of FIG. 2B and date 216 of FIG. 2A may identify the same date, date 246 of FIG. 2B may be different than date 216 of FIG. 2A.

Transaction identifier 250 represents any data that may identify a particular transaction. For example, transaction identifier 250 may include one or more numbers, one or more letters, one or more symbols, any other information that identifies a particular transaction, or any combination of the preceding. In particular embodiments, device 14 may utilize transaction identifier 250 in order to search for a particular transaction, manage a particular transaction, or keep track of a particular transaction. In particular embodiments, this may allow device 14 to compare information received in a request confirmation message with information associated with a particular transaction.

In particular embodiments, transaction code 230 may include any other information. For example, transaction code 230 may include information associated with a time, a description of the transaction (e.g., such as for accounting purposes), or any other information.

Transaction code 230 may be in any type of form. For example, transaction code 230 may be in the form of an image, such as a linear bar code (e.g., a code 93, a code 28, or a UPC), a matrix bar code (e.g., a QR code, a MaxiCode, or a ShotCode), a sequence of numbers and/or symbols, any other image, or any combination of the preceding.

In particular embodiments, the information included in transaction code 230 may be embedded in transaction code 230. For example, in particular embodiments where transaction code 230 is in the form of a barcode, one or more bars in the bar code may represent each item of information included in transaction code 230.

FIG. 2C illustrates an example transaction confirmation message 260 that may be received by device 14 in order to facilitate a transaction between a user and a recipient. In particular embodiments, transaction confirmation message 260 may be an example of transaction confirmation message 112 of FIG. 1. According to the illustrated embodiment, transaction confirmation message 260 includes user identifier 264, transaction amount 268, transaction recipient identifier 272, date 276, transaction identifier 280, confirmation 284, and unique identifier 288. In particular embodiments, transaction confirmation message 260 may include more or less information depending on particular implementations.

User identifier 264 represents any data that may identify a particular user. In particular embodiments, user identifier 264 of FIG. 2C may be substantially similar to user identifier 234 of FIG. 2B. In particular embodiments, although user identifier 264 of FIG. 2C and user identifier 234 of FIG. 2B may identify the same user, user identifier 264 of FIG. 2C may be different than user identifier 234 of FIG. 2B.

Transaction amount 268 represents any data that may identify an amount of money that is needed to conduct the transaction between the user and the recipient. In particular embodiments, transaction amount 268 of FIG. 2C may be substantially similar to transaction amount 238 of FIG. 2B. In particular embodiments, although transaction amount 268 of FIG. 2C and transaction amount 238 of FIG. 2B may identify the same amount of money, transaction amount 268 of FIG. 2C may be different than transaction amount 238 of FIG. 2B.

Transaction recipient identifier 272 represents any data that may identify a recipient with which the user desires to conduct a transaction. In particular embodiments, transaction recipient identifier 272 of FIG. 2C may be substantially similar to transaction recipient identifier 242 of FIG. 2B. In particular embodiments, although transaction recipient identifier 272 of FIG. 2C and transaction recipient identifier 242 of FIG. 2B may identify the same recipient, transaction recipient identifier 272 of FIG. 2C may be different than transaction recipient identifier 242 of FIG. 2B.

Date 276 represents any data that may identify a date associated with the transaction. In particular embodiments, date 276 of FIG. 2C may be substantially similar to date 246 of FIG. 2B. In particular embodiments, although date 276 of FIG. 2C and date 246 of FIG. 2B may identify the same date, date 276 of FIG. 2C may be different than date 246 of FIG. 2B.

Transaction identifier 280 represents any data that may identify a particular transaction. In particular embodiments, transaction identifier 280 of FIG. 2C may be substantially similar to transaction identifier 250 of FIG. 2B. In particular embodiments, although transaction identifier 280 of FIG. 2C and transaction identifier 250 of FIG. 2B may identify the same transaction, transaction identifier 280 of FIG. 2C may be different than transaction identifier 250 of FIG. 2B.

Confirmation 284 represents any data that indicates that the user has confirmed that the details of the requested transaction are correct. For example, if the requested transaction was for a transfer of $200 to Person A, confirmation 284 may indicate that the user has confirmed that the requested transaction was for a transfer of $200 to Person A.

Unique identifier 288 represents any data that uniquely identifies the mobile device that communicates transaction confirmation message 260. For example, unique identifier 288 may include an IMEI, an ICCID, an IMSI, an authentication key for a SIM installed in a mobile device, any other identifier that uniquely identifies the mobile device, or any combination of the preceding. In particular embodiments, unique identifier 288 may be an example of unique identifier 66 extracted from mobile device 26. In particular embodiments, device 14 may be able to compare unique identifier 288 to the unique identifier in mobile device information 50 in order to determine that the transaction confirmation request 260 was communicated by a mobile device associated with the user's account. If it was not, the transaction may be unauthorized, and device 14 may prevent the transaction from occurring.

In particular embodiments, transaction confirmation message 260 may include any other information. For example, transaction confirmation message 260 may include information associated with a time, a description of the transaction (e.g., such as for accounting purposes), or any other information.

FIG. 2D illustrates an example data set 300 utilized by device 14 in order to determine whether to approve a transaction. According to the illustrated embodiment, data set 300 includes user account information 304, mobile device information 308, and transaction data 312. In particular embodiments, data set 300 may include more or less information depending on particular implementations. Although FIG. 2D is illustrated with example data, it should be understood that the format and/or representation can be changed without departing from the scope of the present disclosure.

User account information 304 represents any information regarding user and/or commercial accounts handled by device 14. In particular embodiments, user account information 304 may be an example of user account information 46 of FIG. 1. In particular embodiments, data set 300 may include user account information 304 for every user and/or commercial account handled by device 14.

Mobile device information 308 represents any information that may identify a mobile device associated with a user's account. In particular embodiments, mobile device information 308 may be an example of mobile device information 50 of FIG. 1. In particular embodiments, mobile device information 308 is associated with a particular user account information 304. As such, in particular embodiments, by accessing and/or searching for user account information 304 for a particular user, device 14 may be able to determine mobile device information 308 associated with the particular user's account.

Transaction data 312 represents any information associated with a particular transaction. In particular embodiments, transaction data 312 may be an example of transaction data 54 of FIG. 1. In particular embodiments, transaction data 312 may be associated with user account information 304 for a particular user. As such, in particular embodiments, by searching for and/or accessing user account information 304 for a particular user, device 14 may be able to determine transaction data 312 associated with the user's account.

In particular embodiments, data set 300 may allow device 14 to determine whether to approve a transaction. For example, after device 14 receives a transaction confirmation message (such as transaction confirmation message 112 or transaction confirmation message 260), device 14 may compare information included in the transaction confirmation message with information included in data set 300. For example, as is discussed in FIG. 2C, transaction confirmation message 260 may include unique identifier 288. As such, device 14 may compare unique identifier 288 to mobile device information 308 associated with the user's account. If they match, device 14 may determine that the transaction confirmation message 260 was received from a mobile device that is associated with the user's account. As such, device 14 may approve the transaction, and therefore may allow the transaction to occur.

In particular embodiments, device 14 may further compare additional information included in transaction confirmation message 260 with information included in data set 300. For example, as is discussed in FIG. 2C, transaction confirmation message 260 includes user identifier 264, transaction amount 268, and transaction recipient identifier 272. In particular embodiments, after device 14 receives transaction confirmation message 260, device 14 may compare user identifier 264, transaction amount 268, and transaction recipient identifier 272 to information included in transaction data 312 for that particular transaction. In particular embodiments, such a comparison may be made based on transaction identifier 280 of transaction confirmation message 260. In particular embodiments, if the information matches, device 14 may determine that none of the information for the transaction has been altered. As such, device 14 may approve the transaction, and therefore may allow the transaction to occur.

In particular embodiments, device 14 may approve the transaction (and therefore may allow the transaction to occur) if unique identifier 288 in transaction confirmation message 260 matches mobile device information 308 associated with the particular user's account, and/or if one or more of user identifier 264, transaction amount 268, and/or transaction recipient identifier 272 included in transaction confirmation 260 matches information included in transaction data 312 for the particular transaction.

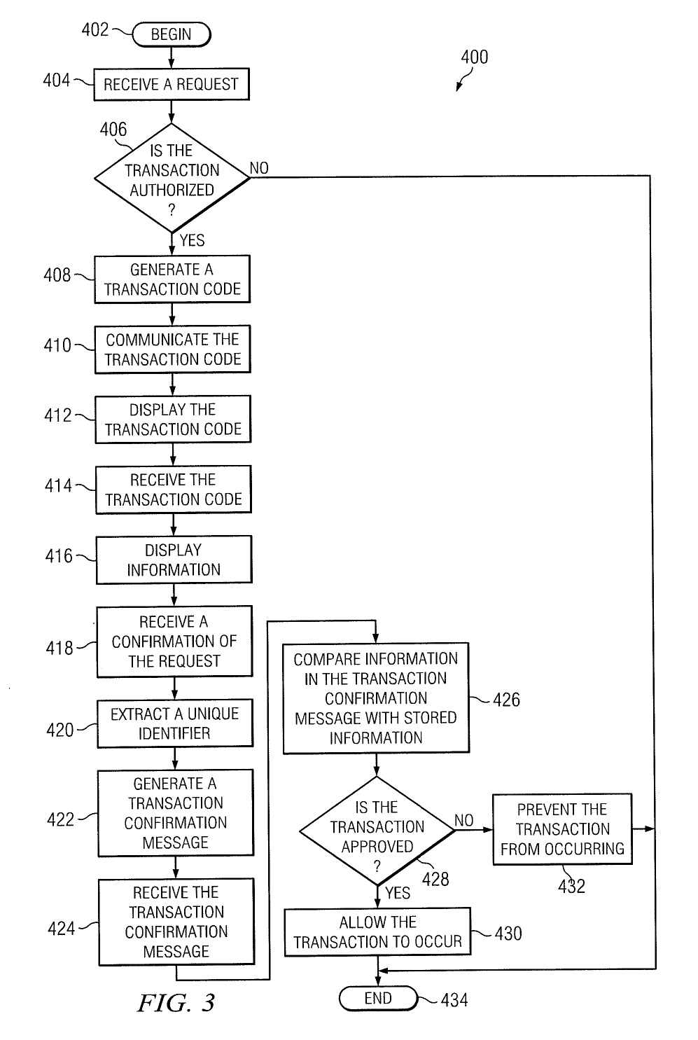

FIG. 3 illustrates a method 400 for facilitating transactions between users and recipients. In particular embodiments, one or more steps of method 400 may be performed by device 14, user device 22, and/or mobile device 26.

The method begins at step 402. At step 404, a request to perform a transaction between a user and a recipient is received. In particular embodiments, the request may be received by device 14 from user device 22. In particular embodiments, the request may include a user identifier, a transaction amount, and a transaction recipient identifier.

At step 406, it is determined whether the transaction between the user and the recipient is authorized. In particular embodiments, device 14 may determine to authorize the transaction in any manner. For example, device 14 may compare a dollar amount of the transaction with a remaining balance in an account associated with the user. If the transaction is not authorized, the method moves to step 434 where the method ends. If the transaction is authorized, the method moves to step 408.

At step 408, a transaction code is generated. For example, transaction code 230 may be generated. In particular embodiments, the transaction code may be generated by device 14. In particular embodiments, the transaction code is generated in response to a determination that the request for the transaction is authorized. In particular embodiments, the transaction code may be generated based on the user identifier, the transaction amount, and the transaction recipient identifier. In particular embodiments, the transaction code includes the user identifier, the transaction amount, the transaction recipient identifier, a transaction identifier, and a date associated with the transaction. In particular embodiments, the transaction code may be an image in the form of a linear bar code (such as a code 93, a code 128, or a UPC) or a matrix bar code (such as a QR code, a MaxiCode, or a ShotCode).

At step 410, the transaction code is communicated. In particular embodiments, the transaction code may be communicated by device 14 to user device 22. In particular embodiments, the transaction code may be transmitted using transaction code message 104.

At step 412, the transaction code is displayed. In particular embodiments, the transaction code may be displayed by user device 22. In particular embodiments, the transaction code may be displayed by a graphical user interface displayed on user device 22. In particular embodiments, the transaction code may be displayed as an image in the form of a linear bar code or a matrix bar code.

At step 414, the transaction code is received. In particular embodiments, the transaction code may be received by mobile device 26 from user device 22. In particular embodiments, mobile device 26 may receive the transaction code in any manner. In particular embodiments, mobile device 26 may receive the transaction code via reception method 108. For example, mobile device 26 may take (or receive) a picture of the transaction code displayed on user device 22. In particular embodiments, taking, or receiving a picture of the transaction code displayed on user device 22 may include mobile device 26 scanning the transaction code included in the picture so as to extract information from the transaction code. In particular embodiments, mobile device 26 may also scan the transaction code directly from the graphical user interface displayed on user device 22.

At step 416, information regarding the transaction is displayed. In particular embodiments, mobile device 26 may display the information. In particular embodiments, mobile device 26 may display any information from the transaction code. For example, if the requested transaction was for a transfer of $200 to Person A, mobile device 26 may display a message that indicates that a $200 transfer to Person A was requested. In particular embodiments, this may allow a user to determine whether details associated with the requested transaction are correct.

At step 418, a confirmation of the request is received. In particular embodiments, the confirmation of the request is received by mobile device 26. In particular embodiments, the confirmation may be communicated to mobile device 26 in any manner. For example, the user may select a confirmation button displayed on mobile device 26 by mobile application 62, the user may provide a vocal confirmation, or the user may perform any other manner of confirmation. In particular embodiments, the confirmation of the request indicates that the user has determined that the displayed details regarding the requested transaction are correct. In particular embodiments, if the user fails to provide a confirmation of the requested transaction, or the user provides an indication that the displayed details are not correct, the transaction may be prevented from occurring and the method may end.

After the confirmation of the request is received, the method moves to step 420, where a unique identifier is extracted. In particular embodiments, mobile application 62 of mobile device 26 may extract the unique identifier from the mobile device. In particular embodiments, mobile application 62 may dynamically extract the unique identifier from mobile device 26. In particular embodiments, the unique identifier may represent any identifier that may uniquely identify mobile device 26.

At step 422, a transaction confirmation message is generated. In particular embodiments, a transaction confirmation message is generated by mobile application 62 of mobile device 26. In particular embodiments, the transaction confirmation message includes a confirmation of the request for the transaction, the unique identifier of the mobile device, and/or transaction information regarding the transaction.

At step 424, the transaction confirmation message is received. In particular embodiments, the transaction confirmation message is received by device 14 after being communicated by mobile device 26.

At step 426, information in the transaction confirmation message is compared with stored information. In particular embodiments, device 14 compares information in the transaction confirmation message with stored information. In particular embodiments, the comparison may include comparing the unique identifier of mobile device 26 with the stored mobile device information associated with the user account. In particular embodiments, the comparison may include comparing the transaction information included in the transaction confirmation message with the user identifier, the transaction amount, and the transaction recipient identifier associated with the request. In particular embodiments, comparing the information may include determining whether the information matches the stored information.

At step 428, it is determined whether the transaction is approved. In particular embodiments, device 14 determines whether the transaction is approved. In particular embodiments, the transaction may be approved in response to a determination that the unique identifier of mobile device 26 matches the stored mobile device information associated with the user and/or that the transaction information included in the transaction confirmation message matches the user identifier, the transaction amount, and the transaction recipient identifier associated with the request.

If it is determined that the transaction is approved, the method moves to step 430 where the transaction is allowed to occur. In particular embodiments, allowing the transaction to occur includes facilitating a transfer of the transaction amount to the recipient associated with the transaction recipient identifier. After the transaction is allowed to occur, the method moves to step 434, where the method ends.

On the other hand, if it is determined that the transaction is not approved, the method moves to step 432 where the transaction is prevented from occurring. In particular embodiments, the transaction may be prevented from occurring in any suitable manner. For example, all information regarding the transaction may be deleted, the transaction information regarding the transaction may be prevented from being processed, or any other suitable manner of preventing the transaction from occurring may be conducted. After the transaction is prevented from occurring, the method moves to step 434, where the method ends.

Modifications, additions, or omissions may be made to method 400. For example, although method 400 illustrates the transaction code being communicated to user device 22, in particular embodiments, device 14 may communicate the transaction code directly to mobile device 26. Additionally, one or more steps in method 400 in FIG. 3 may be performed in parallel or in any suitable order.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A system comprising:
a memory capable to store user account information associated with a user and mobile device information associated with the user account; and
a processor communicatively coupled to the memory and capable to:
receive a request for a transaction associated with the user account, the request comprising a user identifier, a transaction amount, and a transaction recipient identifier;
generate a transaction code based on the user identifier, the transaction amount, and the transaction recipient identifier;
communicate the transaction code to a user device;
receive, from a mobile device, a transaction confirmation message, the transaction confirmation message comprising a confirmation of the request for the transaction and a unique identifier of the mobile device;
compare the unique identifier of the mobile device with the stored mobile device information associated with the user account; and
in response to a determination that the unique identifier of the mobile device matches the stored mobile device information associated with the user account, allow the transaction to occur; and
wherein the user device and the mobile device are separate devices.

2. The system of claim 1, wherein:
the transaction confirmation message further comprises transaction information; and
the processor is further capable to:
compare the transaction information with the user identifier, the transaction amount, and the transaction recipient identifier associated with the request; and
in response to both the determination that the unique identifier of the mobile device matches the stored mobile device information associated with the user account and a determination that the transaction information matches the user identifier, the transaction amount, and the transaction recipient identifier associated with the request, allow the transaction to occur.

3. The system of claim 1, further comprising a mobile application for execution on the mobile device, the mobile application capable, upon execution, to dynamically extract the unique identifier of the mobile device.

4. The system of claim 3, further comprising a graphical user interface displayed on the user device, the graphical user interface capable to display the transaction code; and
wherein the mobile application is further capable, upon execution, to:
scan the displayed transaction code in order to receive the transaction code from the graphical user interface;
display information included in the transaction code;
receive the confirmation of the request for the transaction;
generate the transaction confirmation message; and
communicate the transaction confirmation message.

5. The system of claim 1, wherein the transaction code is an image selected from a group consisting of:
a Code 93;
a Code 128;
a Universal Product Code (UPC);
a Quick Response (QR) code;
a MaxiCode; and
a ShotCode.

6. The system of claim 1, wherein the transaction code includes data selected from a group consisting of:
the user identifier;
the transaction amount;
the transaction recipient identifier;
a transaction identifier; and
a date associated with the transaction.

7. The system of claim 1, wherein the unique identifier of the mobile device comprises an identifier selected from a group consisting of:
an International Mobile Equipment Identity (IMEI);
an Integrated Circuit Card Identifier (ICCID);
an International Mobile Subscriber Identity (IMSI); and
an authentication key for a subscriber identification module (SIM) installed in the mobile device.

8. The system of claim 1, wherein the processor capable to allow the transaction to occur comprises the processor capable to facilitate a transfer of the transaction amount to a recipient associated with the transaction recipient identifier.

9. Logic embedded in a non-transitory computer readable storage medium and capable, when executed by a processor, to:
access user account information associated with a user and mobile device information associated with the user account; and
receive a request for a transaction associated with the user account, the request comprising a user identifier, a transaction amount, and a transaction recipient identifier;
generate a transaction code based on the user identifier, the transaction amount, and the transaction recipient identifier;
communicate the transaction code to a user device;
receive, from a mobile device, a transaction confirmation message, the transaction confirmation message comprising a confirmation of the request for the transaction and a unique identifier of the mobile device;
compare the unique identifier of the mobile device with the mobile device information associated with the user account; and
in response to a determination that the unique identifier of the mobile device matches the mobile device information associated with the user account, allow the transaction to occur; and
wherein the user device and the mobile device are separate devices.

10. The logic of claim 9, wherein:
the transaction confirmation message further comprises transaction information; and
the logic is further capable to:
compare the transaction information with the user identifier, the transaction amount, and the transaction recipient identifier associated with the request; and
in response to both the determination that the unique identifier of the mobile device matches the mobile device information associated with the user account and a determination that the transaction information matches the user identifier, the transaction amount, and the transaction recipient identifier associated with the request, allow the transaction to occur.

11. The logic of claim 9, further comprising a mobile application for execution on the mobile device, the mobile application capable, upon execution, to dynamically extract the unique identifier of the mobile device.

12. The logic of claim 11, wherein the mobile application is further capable, upon execution, to:
scan the transaction code displayed by a graphical user interface displayed on a user device in order to receive the transaction code from the graphical user interface;
display information included in the transaction code;
receive the confirmation of the request for the transaction;
generate the transaction confirmation message; and
communicate the transaction confirmation message.

13. The logic of claim 9, wherein the transaction code is an image selected from a group consisting of:
a Code 93;
a Code 128;
a Universal Product Code (UPC);
a Quick Response (QR) code;
a MaxiCode; and
a ShotCode.

14. The logic of claim 9, wherein the transaction code includes data selected from a group consisting of:
the user identifier;
the transaction amount;
the transaction recipient identifier;
a transaction identifier; and
a date associated with the transaction.

15. The logic of claim 9, wherein the logic capable to allow the transaction to occur comprises the logic capable to facilitate a transfer of the transaction amount to a recipient associated with the transaction recipient identifier.

16. A method comprising:
accessing user account information associated with a user and mobile device information associated with the user account;
receiving a request for a transaction associated with the user account, the request comprising a user identifier, a transaction amount, and a transaction recipient identifier;
generating, by a processor, a transaction code based on the user identifier, the transaction amount, and the transaction recipient identifier;
communicating the transaction code to a user device;
receiving, from a mobile device, a transaction confirmation message, the transaction confirmation message comprising a confirmation of the request for the transaction and a unique identifier of the mobile device;
comparing the unique identifier of the mobile device with the mobile device information associated with the user account;
in response to a determination that the unique identifier of the mobile device matches the mobile device information associated with the user account, allowing the transaction to occur; and
wherein the user device and the mobile device are separate devices.

17. The method of claim 16, wherein:
the transaction confirmation message further comprises transaction information; and
the method further comprises:
comparing the transaction information with the user identifier, the transaction amount, and the transaction recipient identifier associated with the request; and
in response to both the determination that the unique identifier of the mobile device matches the mobile device information associated with the user account and a determination that the transaction information matches the user identifier, the transaction amount, and the transaction recipient identifier associated with the request, allowing the transaction to occur.

18. The method of claim 16, further comprising dynamically extracting the unique identifier of the mobile device.

19. The method of claim 18, further comprising:
displaying the transaction code;
scanning the displayed transaction code in order to receive the transaction code;
displaying information included in the transaction code;
receiving the confirmation of the request for the transaction;
generating the transaction confirmation message; and
communicating the transaction confirmation message.

20. The method of claim 16, wherein the transaction code is an image selected from a group consisting of:
a Code 93;
a Code 128;
a Universal Product Code (UPC);
a Quick Response (QR) code;
a MaxiCode; and
a ShotCode.

21. The method of claim 16, wherein the transaction code includes data selected from a group consisting of:
the user identifier;
the transaction amount;
the transaction recipient identifier;
a transaction identifier; and
a date associated with the transaction.

22. The method of claim 16, wherein allowing the transaction to occur comprises facilitating a transfer of the transaction amount to a recipient associated with the transaction recipient identifier.
